(19) United States
(12) Patent Application Publication
(10) Pub. No.: US 2022/0188926 A1
(43) Pub. Date: Jun. 16, 2022

(54) MANAGEMENT DEVICE, CONTROL METHOD AND STORAGE MEDIA

(71) Applicant: NEC Corporation, Minato-ku, Tokyo (JP)

(72) Inventors: Masafumi OYAMADA, Tokyo (JP); Keigo KIMURA, Tokyo (JP); Kunihiro TAKEOKA, Tokyo (JP)

(73) Assignee: NEC Corporation, Minato-ku, Tokyo (JP)

(21) Appl. No.: 17/442,156

(22) PCT Filed: Mar. 28, 2019
(86) PCT No.: PCT/JP2019/013763

§ 371 Date: Sep. 23, 2021

(51) Int. Cl. G06Q 40/04

(52) U.S. Cl. CPC G06Q 40/04

(57) ABSTRACT

The acquisition unit 52A acquires request information S1, which is information regarding possession data owned by a data owner, from an owner terminal 2 used by the data owner. The determination unit 53A determines whether or not there is shortage data other than the possession data required to perform a designation task that is designated. The notification unit 54A notifies, when the determination unit 53A determines that there is the shortage data, the owner terminal 2 of shortage data information S2 that is information regarding shortage information.

### TECHNICAL FIELD

The present invention relates to a technical field of a management device, a control method, and a storage medium for managing data.

### BACKGROUND ART

An intermediary system is known to mediate between sellers and buyers through a communication network. For example, Patent Literature 1 discloses an intermediary system configured to display to the seller the order information excluding the identification information of the buyer and then display to the buyer a list of bidding information the seller has entered in response to the order information.

### PRIOR ART DOCUMENTS

### Patent Literature

Patent Literature 1: JP 2001-319093A

### SUMMARY OF THE INVENTION

### Problem to be Solved by the Invention

In some cases, data owners who collect and manage the data cannot appropriately utilize their possession data in large quantities. Some of such data owners have not been able to utilize data since they lack the necessary data, even though there are tasks such as data analysis that they want to perform. No mechanism for supporting such a data owner is disclosed in Patent Literature 1.

In view of the above-described issues, it is therefore an example object of the present disclosure to provide a management device, a control method and a storage medium capable of suitably providing useful information to the data owner.

### Means for Solving the Problem

One mode of the management device is a management device including: an acquisition unit configured to acquire information regarding data owned by a data owner from an owner terminal which the data owner uses; a determination unit configured to determine whether or not there is shortage data other than the data required to perform designation task that is designated; and a notification unit configured to notify, when the determination unit determines that there is the shortage data, the owner terminal of information regarding the shortage data.

One mode of the control method is a control method executed by a management device, the control method including: acquiring information regarding data owned by a data owner from an owner terminal which the data owner uses; determining whether or not there is shortage data other than the data required to perform designation task that is designated; and notifying, when it is determined that there is the shortage data, the owner terminal of information regarding the shortage data.

One mode of the storage medium is a storage medium storing a program executed by a computer, the program causing the computer to function as: an acquisition unit configured to acquire information regarding data owned by a data owner from an owner terminal which the data owner uses; a determination unit configured to determine whether or not there is shortage data other than the data required to perform designation task that is designated; and a notification unit configured to notify, when the determination unit determines that there is the shortage data, the owner terminal of information regarding the shortage data.

### Effect of the Invention

An example advantage according to the present invention is to notify the data owner of information regarding the data that the data owner lacks to perform the task designated by the data owner. This makes it possible to suitably support the data owner who is unable to perform the task due to the lack of the data even though there is a task which the data owner hopes to perform.

### BRIEF DESCRIPTION OF THE DRAWINGS

FIG. 1 illustrates a configuration of a data market system according to a first example embodiment.

FIG. 2 illustrates a schematic configuration of a management device.

FIG. 3 illustrates a schematic configuration of an owner terminal used by a data owner.

FIG. 4 illustrates a schematic configuration of a terminal device used by a task performer.

FIG. 5 illustrates a schematic configuration of a terminal device used by a data provider.

FIG. 6 illustrates an example of a data structure of possession data information.

FIG. 7 illustrates an example of a data structure of task information.

FIG. 8 illustrates an example of a data structure of data provider information.

FIG. 9 illustrates an example of a functional block of the management device.

FIG. 10 illustrates a display example of a task selection view.

FIG. 11 illustrates a display example of a data selection view.

FIG. 12 illustrates an example of a flowchart according to the first example embodiment.

FIG. 13 illustrates a functional block diagram of a management device according to a second example embodiment.

### DESCRIPTION OF EXAMPLE EMBODIMENTS

Hereinafter, with reference to the drawings, example embodiments relating to a management device, a control method and a storage medium will be described.

### First Example Embodiment

(1-1) Configuration of Data Market System

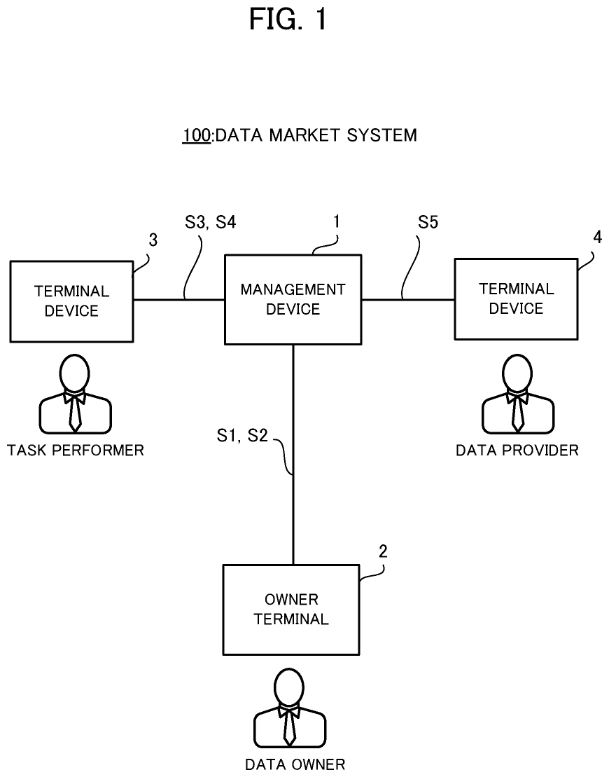

FIG. 1 illustrates a configuration of a data market system 100 according to the first example embodiment. The data market system 100 mainly includes a management device 1 for managing data and tasks, an owner terminal 2 used by a data owner who owns the data, a terminal device 3 used by a task performer, and a terminal device 4 used by a data provider that provides the data. The term “task” herein indicates processing relating to any of various data analyses such as, for example, demand analysis of commodities and cancellation analysis of insurance products. Data communication via a communication network or the like is performed between the management device 1 and the owner terminal 2, between the management device 1 and the terminal device 3 and between the management device 1 and the terminal device 4, respectively.

Though there are only present one owner terminal 2, one terminal device 3, and one terminal device 4 in FIG. 1, a plurality of owner terminals 2, a plurality of terminal device 3 and a plurality of terminal device 4 may be present, respectively. In addition, the terms “data owner”, “task performer” and “data provider” shall include not only individuals but also organizations such as companies.

The management device 1 receives a predetermined request information (also referred to as “request information S1”) specifying the data owned by the data owner from the owner terminal 2. In this case, the management device 1 determines whether or not there is data (also referred to as “shortage data”) which the data owner lacks to perform the task (also referred to as “designation task”), which is designated by the data owner, by use of the data indicated by the request information S1. Then, the management device 1 transmits information (also referred to as “shortage data information S2”) regarding the shortage data to the owner terminal 2.

Here, the “designation task” is a task designated by the data owner, and, for example, the management device 1 receives the information indicative of the designation task as a part of the request information S1. In another example, the management device 1 notifies the owner terminal 2 of tasks (also referred to as “recommended tasks”) that are recommended as a task for utilizing data owned by the data owner, and determines the designation task to be the recommended task selected from the notified recommended tasks by the owner terminal 2. In addition, the term “shortage data” is not limited to data (i.e., data essential to the designation task) without which the designation task cannot be performed, but also includes data without which the accuracy of the designation task is decreased compared to the case where the designation task is performed by use of the shortage data.

Further, the management device 1 transmits, to the terminal device 3 which the task performer uses, information (also referred to as “task request information S3”) based on a request from the owner terminal 2, wherein the task request information S3 requests execution of the task while specifying data of the owner terminal 2 to be used for the task. The management device 1 receives, as a response to the task request information S3, information (also referred to as “task performance information S4”) indicating the result of the task performed by the terminal device 3 from the terminal device 3. Further, the management device 1 receives information (also referred to as “data providing information S5”) regarding data (i.e., target of sale) to be provided by the data provider from the terminal device 4 which the data provider uses.

The owner terminal 2 generates the request information S1 relating to data (also referred to as “possession data”) which the data owner owns (possesses) and transmits the request information S1 to the management device 1. The request information S1 may include the possession data itself, or may include information (i.e., metadata) for identifying the possession data in place of the possession data itself. The possession data is not limited to one type of data and it may include a plurality of types of data. Further, when the owner terminal 2 receives the shortage data information S2 from the management device 1 as a response to the request information S1, the owner terminal 2 displays information based on the shortage data information S2. The display example based on the shortage data information S2 will be described later.

When the terminal device 3 receives the task request information S3 from the management device 1, the terminal device 3 performs the task specified by the task request information S3 by using the data specified by the task request information S3. The terminal device 3 transmits the task performance information S4 indicating the execution result of the task to the management device 1.

The terminal device 4 generates the data providing information S5 related to data (also referred to as “providing data”) designated by the data provider as data for sale (i.e., target of supply), and transmits the data providing information S5 to the management device 1. The data providing information S5 may include the providing data itself (raw data) or may include information (i.e., metadata) for identifying the providing data instead of the raw data thereof In the latter case, when the contract of trade of the providing data between the data provider and the data owner is made, the terminal device 4 may directly transmit the providing data to the owner terminal 2 corresponding to the data owner that is the buyer of the providing data.

The configuration of the data market system 100 is not limited to the configuration shown in FIG. 1. For example, instead of transmitting the task performance information S4 to the management device 1, the terminal device 3 may transmit the task performance information S4 to the owner terminal 2. Further, instead of the terminal device 3 performing the task based on the task request information S3, the management device 1 or the owner terminal 2, which has received a program required for performing the task from the terminal device 3, may perform the task.

(1-2) Device Configuration

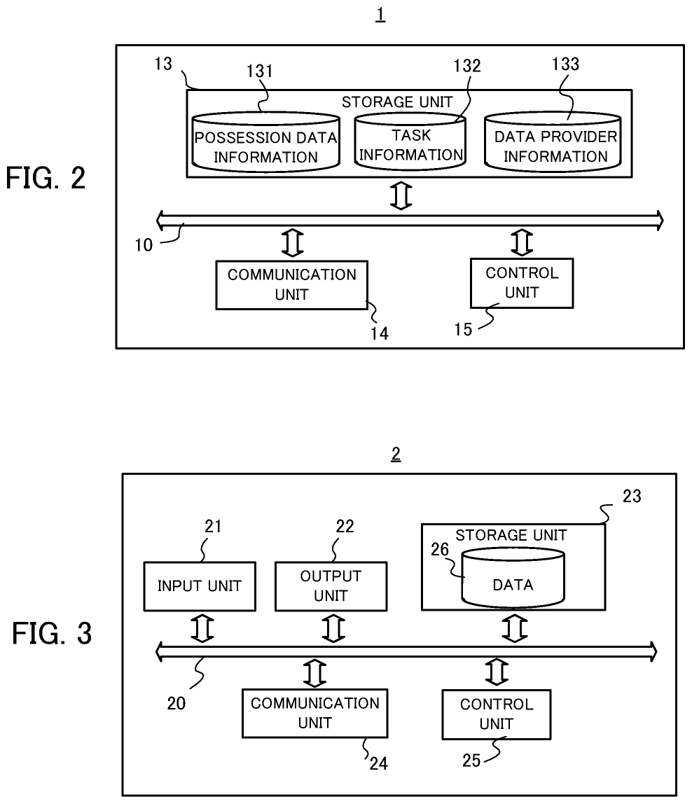

Next, the respective configurations of the management device 1, the owner terminal 2, the terminal device 3 and the terminal device 4 will be described with reference to FIGS. 2 to 5.

FIG. 2 illustrates a schematic configuration of the management device 1. The management device 1 mainly includes a storage unit 13, a communication unit 14 for performing data communication and a control unit 15.

The storage unit 13 is configured by memories such as a hard disk and a flash memory. The storage unit 13 stores a program to be executed by the control unit 15 and other information necessary for the control unit 15 to execute a predetermined process by executing the program. The above-described program may be stored in any storage medium other than the storage unit 13.

The storage unit 13 stores possession data information 131, task information 132 and data provider information 133.

The possession data information 131 is information relating to the possession data and is generated based on the request information S1 received from the owner terminal 2. A specific example of the data structure of the possession data information 131 will be described later.

The task information 132 is information regarding the task that the management device 1 can propose to the owner terminal 2. For example, the task information 132 includes, for each of tasks, data necessary for performing the task, the price range, the accuracy of the task, the effect of performing the task and information on the task performer. The task information 132 is generated, for example, based on the registration information regarding the task performer transmitted from the terminal device 3 to the management device 1. A specific example of the data structure of the task information 132 will be described later.

The data provider information 133 is information regarding the data provider which uses the terminal device 4 and is generated based on the data providing information S5. As will be described below, the data provider information 133 includes the identification information representing the data provider and information regarding the providing data which the data provider provides.

The control unit 15 includes a CPU (Central Processing Unit), a ROM (Read Only Memory) and a RAM (Random Access Memory) which are not shown and performs various controls for the components in the management device 1. The control unit 15 functions as a computer for executing a program. The process which the control unit 15 executes will be described later.

FIG. 3 illustrates a schematic configuration of the owner terminal 2. The owner terminal 2 mainly includes an input unit 21, an output unit 22, a storage unit 23, a communication unit 24 for performing data communication and a control unit 25. Each of these elements is connected to one another via a bus line 20.

The input unit 21 is an interface that accepts an input of a user, and corresponds to, for example, a touch panel, a button, a voice input device and/or the like. The output unit 22 is an interface for outputting information to the user such as a display for displaying information and a speaker for outputting sound.

The storage unit 23 is configured by memories such as a hard disk and a flash memory. The storage unit 23 stores a program to be executed by the control unit 25, and other information necessary for the control unit 25 to execute a predetermined process by executing a program. The storage unit 23 stores the data 26 including the possession data.

The control unit 25 includes a CPU a ROM and a RAM which are not shown, and performs various controls for each component in the owner terminal 2. For example, the control unit 25 generates a request information S1 that specifies the possession data designated by the input unit 21, and transmits the request information to the management device 1 through the communication unit 24. Further, when receiving the shortage data information S2 from the management device 1 through the communication unit 24, the control unit 25 displays information based on the shortage data information S2 by controlling the output unit 22.

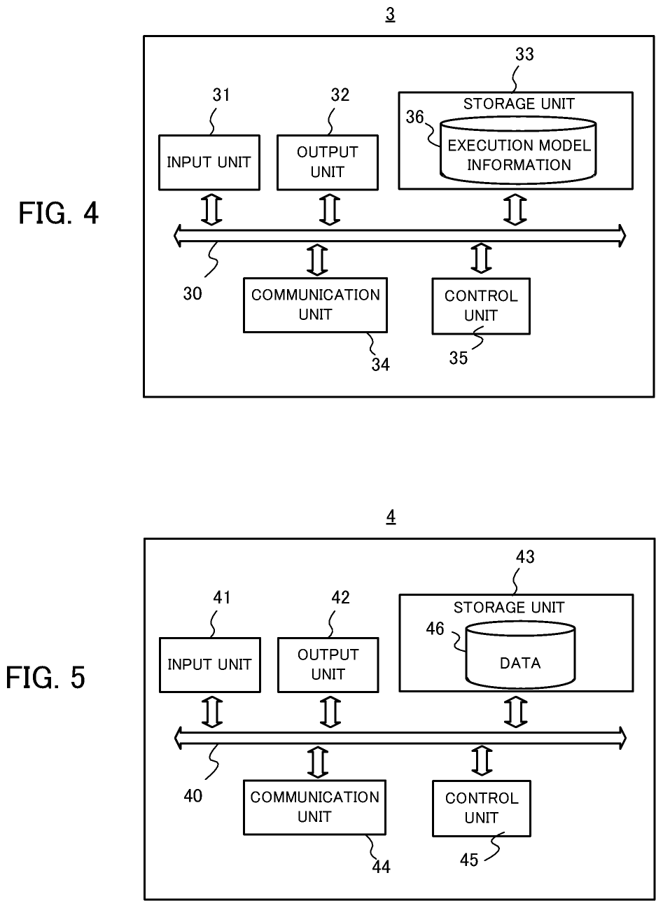

FIG. 4 illustrates a schematic configuration of the terminal device 3. The terminal device 3 mainly includes an input unit 31, an output unit 32, a storage unit 33, a communication unit 34 for performing data communication and a control unit 35. Each of these elements is connected to one another via a bus line 30.

The input unit 31 is an interface that accepts an input of a user, and corresponds to, for example, a touch panel, a button, a voice input device and/or the like. The output unit 32 is an interface for outputting information to the user such as a display for displaying information and a speaker for outputting sound.

The storage unit 33 is configured by memories such as a hard disk and a flash memory. The storage unit 33 stores a program to be executed by the control unit 35, and information necessary for the control unit 35 to execute a predetermined process by executing a program.

Further, the storage unit 33 stores the execution model information 36. The execution model information 36 is information regarding execution models necessary for executing tasks by the task performer who is the user of the terminal device 3. For example, the execution model information 36 includes programs for execution models such as analysis engines and analysis scripts.

The control unit 35 includes a CPU, a ROM and a RAM which are not shown and performs various controls for each component in the terminal device 3. For example, when the communication unit 34 receives the task request information S3 from the management device 1, the control unit 35 applies the execution model specified by the task request information S3 to the possession data indicated by the task request information S3 based on the execution model information 36. Then, the control unit 35 transmits information indicating the execution result to the management device 1 as the task performance information S4 through the communication unit 34.

FIG. 5 illustrates a schematic configuration of the terminal device 4. The terminal device 4 mainly includes an input unit 41, an output unit 42, a storage unit 43, a communication unit 44 for performing data communication and a control unit 45. Each of these elements is connected to one another via a bus line 40.

The input unit 41 is an interface that accepts an input of a user, and corresponds to, for example, a touch panel, a button, a voice input device and/or the like. The output unit 42 is an interface for outputting information to the user such as a display for displaying information and a speaker for outputting sound.

The storage unit 43 is configured by memories such as a hard disk and a flash memory. The storage unit 43 stores a program which the control unit 45 executes, and stores other information necessary for the control unit 45 to execute a predetermined process by executing a program. The storage unit 43 stores data 46 including the providing data.

The control unit 45 includes a CPU, a ROM and a RAM which are not shown, and performs various controls for each component in the terminal device 4. For example, the control unit 45 generates the data providing information S5 which specifies the providing data designated through the input unit 41, and transmits the data providing information S5 to the management device 1 through the communication unit 44.

(1-3) Data Structure

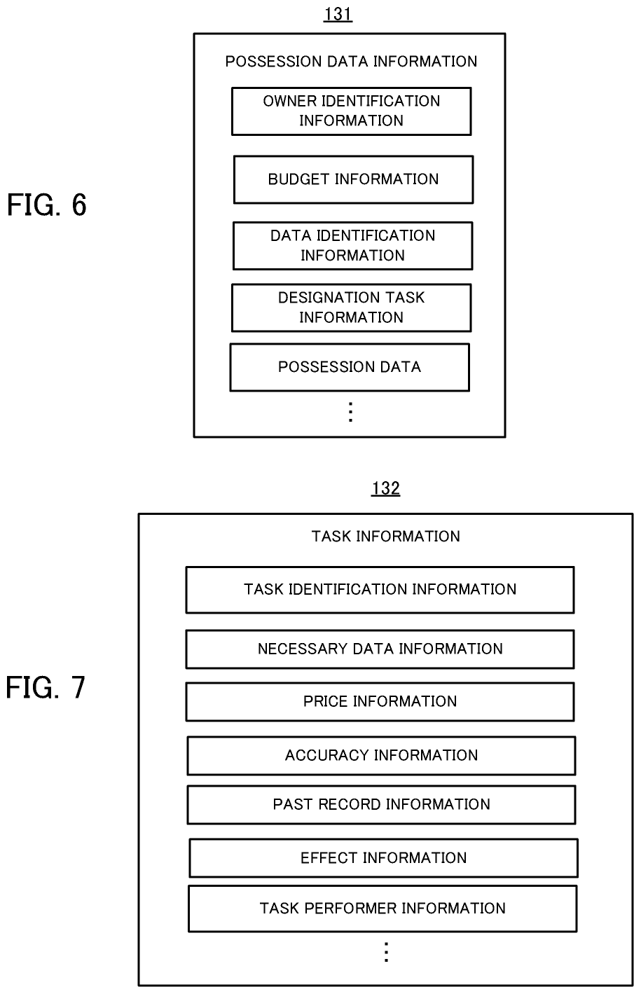

Next, specific examples of each data structure of the possession data information 131, the task information 132, and the data provider information 133 will be described with reference to FIGS. 6 to 8.

FIG. 6 is an example of a data structure of possession data information 131. The possession data information 131 is, for example, information generated for each request information S1 received from the owner terminal 2 and includes owner identification information, budget information, data identification information, designation task information and possession data.

The “OWNER IDENTIFICATION INFORMATION” is information that identifies the data owner of the owner data that is the user of the owner terminal 2. The owner identification information may include information regarding the attributes of the data owner such as the company name, the industry type and the like. The “BUDGET INFORMATION” is information that indicates the budget of the data owner which the data owner can spend on the shortage data. The “BUDGET INFORMATION” may also further include information indicative of the budget of the data owner that the data owner can spend on performing the designation task.

The “DATA IDENTIFICATION INFORMATION” is information (metadata) for identifying the possession data and includes information indicating various attributes of the possession data such as the name of the possession data and the data size thereof. When the possession data includes multiple types of data, the “data identification information” includes information for identifying each of the multiple types of the data. The “DESIGNATION TASK INFORMATION” is information regarding the designation task designated by the data owner as the task which is performed by use of the possession data. The “POSSESSION DATA” is the raw data of the possession data.

The data structure of the possession data information 131 is not limited to the example shown in FIG. 5. For example, the possession data information 131 may not include the “POSSESSION DATA”. In this case, for example, when it is determined to request the task performer to perform the designation task, the owner terminal 2 may directly transmit the possession data to be used for performing the designation task to the terminal device 3 corresponding to the task performer which performs the designation task. When the possession data information 131 is generated based on the request information S1 to which the information regarding the designation task is not added, the “DESIGNATION TASK INFORMATION” is not included in the possession data information 131. In this case, as will be described later, the management device 1 transmits the information regarding the recommended tasks to the owner terminal 2 and, at the time of receiving the information relating to the task selected by the data owner as the response thereto from the owner terminal 2, the management device 1 registers the information relating to the selected task as the designation task information.

FIG. 7 is an example of a data structure of the task information 132. The task information 132 is, for example, information generated for each task that the management device 1 can provide to the data owner. The task information 132 includes task identification information, necessary data information, price information, accuracy information, performance information, effect information, and task performer information.

The “TASK IDENTIFICATION INFORMATION” is the identification information representing the task. The “NECESSARY DATA INFORMATION” indicates the identification information representing the data necessary for performing the task. The term “data necessary for performing the task” is not limited to such data (i.e., essential data for the task) without which the task cannot be performed, but may also include such data without which the accuracy of the task is decreased compared to the case where the task is performed with the data. Further, when there are multiple patterns of combinations of data required for performing the task, the necessary data information may indicate the combination of data for each of the multiple patterns. The “PRICE INFORMATION” indicates the price which is required to perform the task.

The “ACCURACY INFORMATION” indicates the accuracy of the task when the task is performed. In a case where there are multiple patterns of combinations of data indicated by the necessary data information, the accuracy information may be table information or the like indicating the accuracy with respect to each of the multiple patterns. The “PAST RECORD INFORMATION” indicates information (e.g., the number of past records of performing the task) on the past records of performing the task. The “EFFECT INFORMATION” indicates the effect of the task when the task is performed. For example, the effect may be a contribution to the KPI (Key Performance Indicator). In this case, the effect information may be, for example, table information or the like indicating the contribution when the task is performed for each KPI to be assumed.

The “TASK PERFORMER INFORMATION” is information regarding the task performer who performs the task. When there are multiple task performers who perform the target task, the “TASK PERFORMER INFORMATION” is generated for each of the multiple task performers. The “TASK PERFORMER INFORMATION” includes information on the execution model (analysis model) to be used by the task performer to perform the task. Here, the execution model indicates an algorithm for performing a task or a program implementing the algorithm. For example, if the task is a demand analysis for a particular commodity, the execution model indicates an algorithm for performing the demand analysis or a program implementing the algorithm.

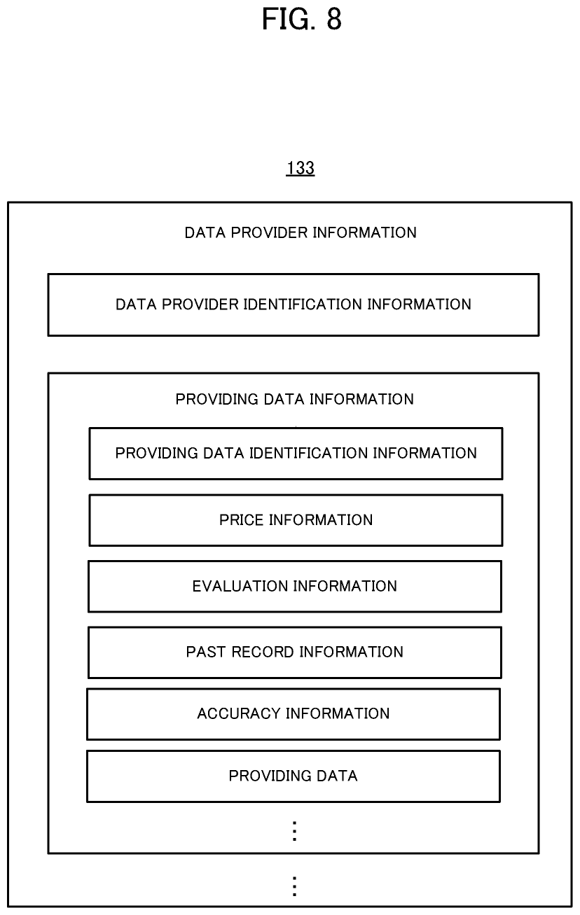

FIG. 8 is an example of a data structure of the data provider information 133. The data provider information 133 is, for example, generated for each data provider corresponding to each terminal device 4. The data provider information 133 includes data provider identification information that is identification information representing the data provider and the providing data information.

The providing data information is information regarding data which the data provider provides. The providing data information is generated for each providing data provided by the data provider and mainly includes providing data identification information, price information, evaluation information, past record information, accuracy information and providing data.

The “PROVIDING DATA IDENTIFICATION INFORMATION” is the identification information representing the providing data. The “PRICE INFORMATION” is information indicating the price set by the data provider for the providing data. The “EVALUATION INFORMATION” indicates the evaluation which the buyer of the providing data in the past gives to the providing data. The “PAST RECORD INFORMATION” is information on the past records of the providing data provided in the data market system 100. The “ACCURACY INFORMATION” is information indicating the increase in the accuracy of the task when the task is performed by additional use of the providing data. For example, the accuracy information may be table information indicating the above-described increase in the accuracy for each task. “PROVIDING DATA” is the raw data of the providing data.

The data provider information 133 is not limited to the data structure shown in FIG. 8. For example, the evaluation information and the past record information may exist independently of the providing data information instead of being included in the providing data information. In this case, the evaluation information may be information indicating the evaluation to each of the data providers. Furthermore, the past record information may be information indicative of the past records of each of the data providers.

(1-4) Functional Block

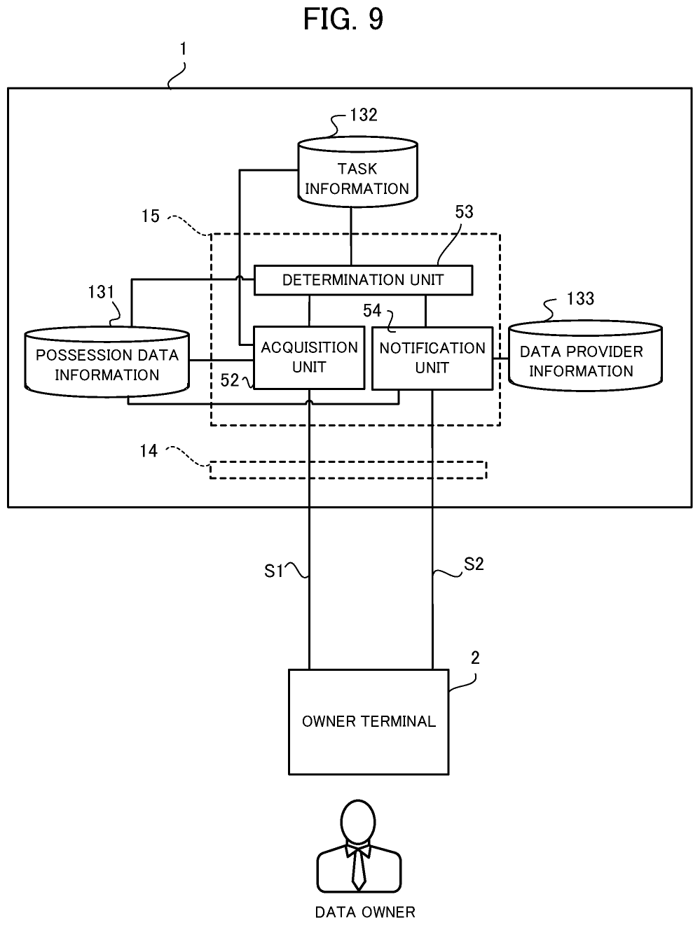

FIG. 9 illustrates an example of a function block of the management device 1 relating to the reception of the request information S1 and the transmission of the shortage data information S2. The control unit 15 of the management device 1 functionally includes an acquisition unit 52, a determination unit 53 and a notification unit 54.

First, a case in which the request information S1 includes the information indicative of the designation task will be described.

The acquisition unit 52 receives the request information S1 via the communication unit 14 from the owner terminal 2. The acquisition unit 52 generates the possession data information 131 based on the received request information S1 and stores the generated possession data information 131 in the storage unit 13. In this case, the acquisition unit 52 acquires the information indicative of the designation task from the owner terminal 2 and adds the acquired information to the possession data information 131 as the designation task information.

The determination unit 53 refers to the possession data information 131 generated by the acquisition unit 52 and the task information 132 and thereby determines whether or not there is shortage data for execution of the designation task.

For example, the determination unit 53 compares the combination of the data indicated by the necessary data information (see FIG. 7) of the task information 132 for the designation task with the combination of the possession data indicated by the data identification information (see FIG. 6) of the possession data information 131. The determination unit 53 regards, as the shortage data, the data that is indicated by the necessary data information and that does not exist in the combination of the possession data. When the shortage data is present, the determination unit 53 supplies information regarding the shortage data to the notification unit 54.

The notification unit 54 transmits the shortage data information S2, which is information relating to the data regarded as shortage data by the determination unit 53, to the owner terminal 2. In this case, by referring to the data provider information 133, the notification unit 54 specifies the data provider that provides the shortage data as the providing data. Then, the notification unit 54 includes the information regarding the data provider in the shortage data information S2 and transmits the shortage data information S2 to the owner terminal 2. Specifically, the notification unit 54 transmits, as the shortage data information S2, display information for displaying a view (also referred to as a “data selection view”) relating to the selection of the shortage data to be purchased and the selection of the data provider providing the shortage data to the owner terminal 2. In this case, preferably, the shortage data information S2 includes: information regarding the increase in the accuracy of the task when the task is performed by additional use of the shortage data; information regarding the price of the shortage data; and identification information representing the data provider who provides the shortage data as the providing data.

Further, the notification unit 54 may generate shortage data information S2 only for the shortage data that can be purchased within the limits of the budget of the data owner and transmit the shortage data information S2 to the owner terminal 2. In this case, the notification unit 54 compares the budget price indicated by the budget information (see FIG. 6) of the possession data information 131 with the price of the providing data according to the price information (see FIG. 8) of the data provider information 133. Then, when the providing data whose price is within the limits of the budget price is present, the notification unit 54 generates information regarding the providing data (i.e., shortage data) as the shortage data information S2.

When receiving the information indicating that there is no shortage data from the determination unit 53, the notification unit 54 transmits to the owner terminal 2, for example, the display information regarding the selection view for selecting the task performer who performs the designation task by use of the possession data. When receiving the response information specifying the task performer from the owner terminal 2, the notification unit 54 transmits the task request information S3 to the terminal device 3 corresponding to the task performer.

Next, a case where the request information S1 does not include the information indicative of the designation task will be described.

In this case, after receiving the request information S1, the acquisition unit 52 performs processing for acquiring the information indicative of the designation task from the owner terminal 2. Specifically, on the basis of the possession data information 131 generated from the request information S1, the acquisition unit 52 selects a task (tasks) that can be performed by use of the possession data as a recommended task (tasks) from the tasks registered in the task information 132.

Here, the term “task that can be performed by use of the possession data” may include not only a task (also referred to as “first task”) that requires no data other than the possession data (i.e., requires only the possession data) for the execution thereof but also a task (also referred to as “second task”) that requires other data in addition to the possession data for the execution thereof. In other words, the “task that can be performed by use of the possession data” may be a task that requires at least possession data.

The acquisition unit 52 transmits to the owner terminal 2 display information for displaying a view (also referred to as “task selection view”) for selecting the designation task from the recommended tasks each corresponding to the first task or the second task. The display example of the task selection view will be described later. When receiving the response information specifying a task on the task selection view from the owner terminal 2, the acquisition unit 52 regards the task indicated by the response information as the designation task and supplies the information indicative of the designation task to the determination unit 53. Thereafter, the determination unit 53 and the notification unit 54 performs the process described above.

(1-5) Display Example

First, a description will be given of a task selection view displayed by the owner terminal 2 when the request information S1 does not include the information indicative of the designation task.

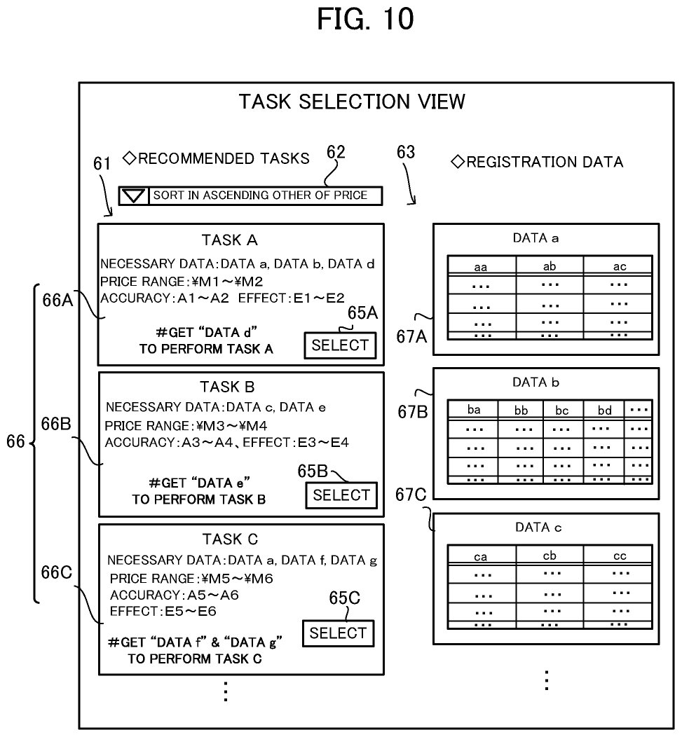

FIG. 10 is a display example of a task selection view displayed on the basis of information regarding the recommended tasks which the owner terminal 2 received from the management device 1. As illustrated in FIG. 10, the acquisition unit 52 of the management device 1 displays a recommended task list 61, a sort selection field 62 and a registration data list 63 on the task selection view on the owner terminal 2.

The recommended task list 61 includes recommended task display fields 66 (66A to 66C) showing information for each of the recommended tasks recommended by the management device 1. Each of the recommended task display fields 66 includes display areas of “NECESSARY DATA”, “PRICE RANGE”, “ACCURACY” and “EFFECT”, and selection buttons 65A to 65C for selecting each of the recommended tasks as the designation task. The acquiring unit 52, for example, acquires information to be displayed in the display areas of “NECESSARY DATA”, “PRICE RANGE”, “ACCURACY” and “EFFECT” by referring to the task information 132.

The acquisition unit 52 displays data necessary for performing the recommended task as the “NECESSARY DATA” in the recommended task display field 66. Further, the acquisition unit 52 displays the price range necessary for performing the recommended task as the “PRICE RANGE” in the recommended task display field 66.

The acquiring unit 52 displays the accuracy when the recommended task is performed as the “ACCURACY” in the recommended task display field 66. Since the accuracy of the task to be performed depends on the execution model to be used, the acquisition unit 52 displays, as the “ACCURACY”, the range of accuracy when each of execution models applicable to the target recommended task is performed, for example. The acquiring unit 52 shows an effect (effectiveness) when the recommended task is performed as the “EFFECT” in the recommended task display field 66. Since the effect differs depending on the execution model to be used, the acquiring unit 52 displays, as the “EFFECT”, the range of the effect when each of the execution models applicable to the recommended task is performed, for example.

In addition, the acquisition unit 52 displays information on shortage data that is necessary to perform the recommended task in the recommended task display field 66 which displays the second task as the recommended task. Thus, the acquiring unit 52 can have the data owner appropriately grasp the data that needs to be newly purchased or generated in order to perform the recommended task.

The acquisition unit 52 displays a sort selection field 62 for determining the order of the recommended task display fields 66 in the recommended task list 61. Here, as an example, the sort selection field 62 is a selection field in a pull-down menu format, and in FIG. 8, the item “SORT IN ASCENDING ORDER OF PRICE” is selected. Then, in this case, for example, the acquiring unit 52 arranges and displays the recommended task display fields 66A to 66C in the ascending other of the corresponding price range (e.g., the lowest price or intermediate price). The sort selection field 62 may have any selection items such as “SORT IN DESCENDING ORDER OF ACCURACY” and “SORT IN DESCENDING ORDER OF EFFECT” in addition to “SORT IN ASCENDING ORDER OF PRICE”. For example, when the item “SORT IN DESCENDING ORDER OF ACCURACY” is selected, the acquiring unit 52 arranges and displays the recommended task display fields 66A to 66C in the descending order of the lowest value or the highest value or the intermediate value of the corresponding accuracy.

The registration data list 63 is a list of possession data which the data owner corresponding to the owner terminal 2 notifies to the management device 1 by the request information S1. The registered data list 63 includes registration data display fields 67A to 67C showing information regarding each possession data. Here, there are at least “DATA a”, “DATA b”, and “DATA c” as the possession data, and the acquiring unit 52 displays data structures thereof on the registered data display fields 67A to 67C, respectively. Thereby, the data owner can appropriately grasp the contents of the possession data which the data owner has.

When detecting the selection of any of the selection buttons 65A to 65C, the acquisition unit 52 regards the recommended task corresponding to the selected button as the designation task and supplies the information regarding the designation task to the determination unit 53.

Next, a data selection view displayed on the basis of the shortage data information S2 will be described.

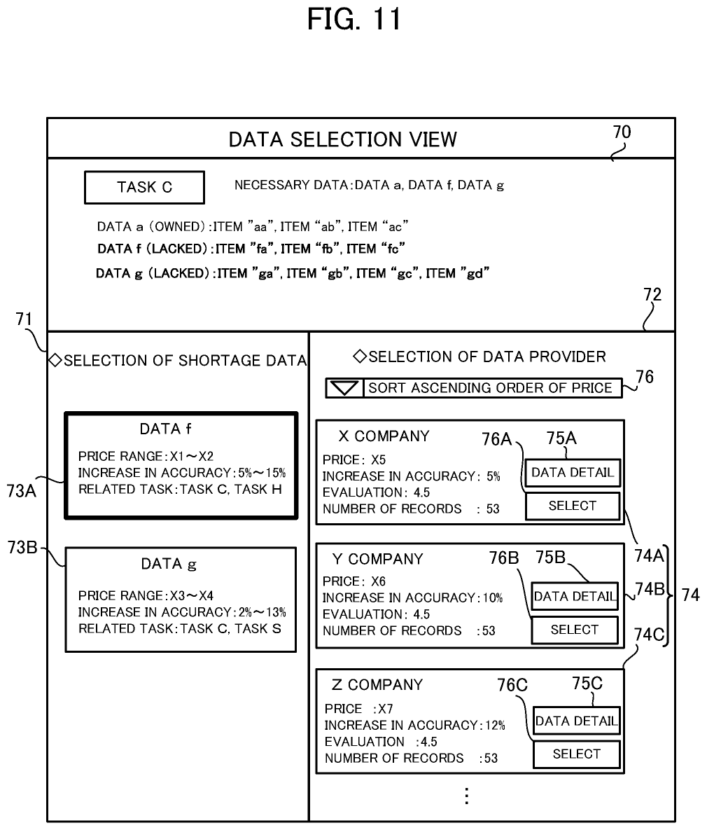

FIG. 11 is a display example of a data selection view when the “TASK C” is a designation task. The data selection view shown in FIG. 11 includes a necessary data display area 70, a shortage data selection area 71 and a data provider selection area 72.

Here, the notification unit 54 displays, on the necessary data display area, the presence or absence of ownership by the target data owner and the data structure of each of the necessary data “DATA a”, “DATA f”, and “DATA g” that are necessary data for performing the designation task “TASK C”. Specifically, the notification unit 54 displays such information that the “DATA a” is owned by the data owner and that the “DATA a” has each item of “aa”, “ab” and “ac”. Further, the notification unit 54 displays such information that the “DATA f” is the shortage data and that the “DATA f” has each item of “fa”, “fb”, and “fc”. Further, the notification unit 54 displays such information that the “DATA g” is the shortage data and that the “DATA g” has each item of “ga”, “gb”, “gc” and “gd”.

Further, the notification unit 54 displays, on the shortage data selection area 71, a shortage data selection button 73A for selecting “DATA f”, which is the shortage data for the task C, as a purchase target and a shortage data selection button 73B for selecting “DATA g”, which is the shortage data for the task C, as a purchase target.

Here, the notification unit 54 displays, on each of the shortage data selection buttons 73A and 73B, the price range of the shortage data, the increase in the accuracy when performing the TASK C by additionally using the shortage data and the related task related to the shortage data. Here, the notification unit 54 displays, as the related task, a task that is (can be) performed by use of the shortage data. Further, according to the example of FIG. 11, the notification unit 54 firstly detects that the shortage data selection button 73A is selected and then highlights the shortage data selection button 73A by highlighting the edge thereof.

Further, the notification unit 54 displays, on the data provider selection area 72, a list of data providers that can provide the shortage data “DATA f”, which corresponds to the shortage data selection button 73A selected in the shortage data selection area 71, as the providing data. Specifically, the notification unit 54 displays the provider display fields 74 (74A to 74C) and the sort selection field 76 on the data provider selection area 72.

The provider display field 74 is a display field for individually displaying information regarding the data provider who provides the shortage data “DATA f” as the providing data. Each provider display field 74 has display areas of “PRICE”, “INCREASE IN ACCURACY”, “EVALUATION”, and “NUMBER OF RECORDS”, and a data detail button 75A, 75B or 75C and a selection button 76A, 76B or 76C in addition to the name of the data provider (company name).

The notification unit 54 displays, as the “PRICE” on the provider display field 74, the price of the shortage data which the data provider provides. For example, the notification unit 54 displays the price described above based on the price information included in the providing data information of the data provider information 133. Further, the notification unit 54 displays, as the “INCREASE IN ACCURACY” on the provider display field 74, the increase in the accuracy calculated on the assumption that the shortage data to be provided by the data provider is additionally used for the designation task. For example, the notification unit 54 displays the accuracy described above on the basis of the accuracy information included in the providing data information of the data provider information 133. Further, the notification unit 54 displays, as the “EVALUATION” to be displayed on the provider display field 74, the evaluation of the providing data to be provided by the target data provider. For example, the notification unit 54 displays the evaluation described above based on the evaluation information included in the providing data information of the data provider information 133. Further, the notification unit 54 displays, as the “NUMBER OF RECORDS” on the provider display field 74, the number of past records of providing the target shortage data. For example, the notification unit 54 displays the number of the past records based on the past record information included in the providing data information of the data provider information 133.

When any of the data detail buttons 75A to 75C is selected, the notification unit 54 displays detailed information regarding the providing data to be provided by the data provider corresponding to the selected one from the data detail buttons 75A to 75C. Furthermore, if any of the selection buttons 76A to 76C is selected, the notification unit 54 determines the seller of the target shortage data to be the data provider corresponding to the selected one from the selection buttons 76A to 76C. Therefore, in this case, the notification unit 54 performs the process in order for the data owner to purchase the shortage data from the data provider corresponding to the selected one from the selection buttons 76A to 76C.

Further, the notification unit 54 displays the sort selection field 76 for determining the order of the provider display fields 74. Here, as an example, the sort selection field 76 is a selection field in a pull-down menu format, and in FIG. 11, the item “SORT IN ORDER OF ASCENDING ORDER OF PRICE” is selected. Then, in this case, the notification unit 54 arranges and displays the provider display fields 74 in the ascending order of the corresponding price. The sort selection field 62 may have any selection items such as “SORT IN DESCENDING ORDER OF INCREASE IN ACCURACY”, “SORT IN DESCENDING ORDER OF EVALUATION” and “SORT IN DESCENDING ORDER OF NUMBER OF RECORDS” in addition to the item “SORT IN ORDER OR ASCENDING ORDER OF PRICE”.

(1-6) Processing Flow

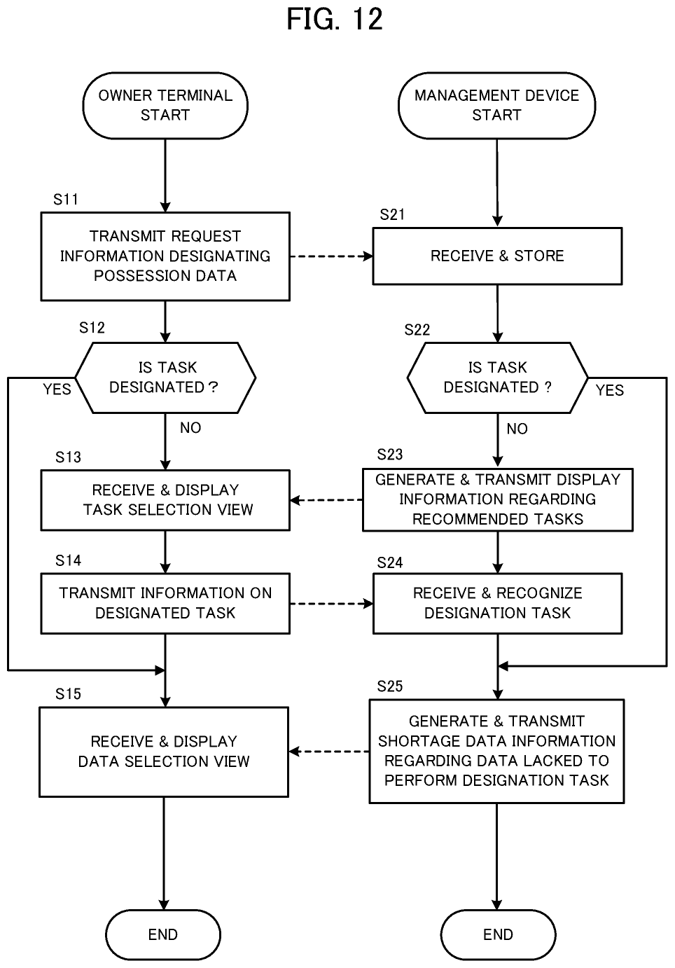

FIG. 12 is an example of a flowchart illustrating a processing procedure of the management device 1 and the owner terminal 2 regarding the display of the data selection view.

First, when detecting the input relating to the designation of the possession data through the input unit 21, the owner terminal 2 generates a request information S1 regarding the designated possession data, and transmits the request information S1 to the management device 1 (step S11). In this case, when the input unit 21 detects an input that designates the designation task, the owner terminal 2 transmits information on the designation task to the management device 1 as a part of the request information S1.

The management device 1 receives the request information S1 from the owner terminal 2 and stores the possession data information 131 based on the request information S1 (step S21). Then, the management device 1 determines whether or not a designation task is designated in the request information S1 (step S22). When the designation task is designated in the request information S1 (step S22; YES), the management device 1 proceeds with process at step S25. In contrast, when the designation task is not designated in the request information S1 (step S22; NO), the management device 1 generates display information regarding the recommended tasks that can be performed by use of the possession data indicated by the request information S1 and transmits the display information to the owner terminal 2 (step S23).

On the other hand, when the designation task is designated at step S11 (step S12; YES), the owner terminal 2 proceeds with the process at step S15. Meanwhile, when the designation task is not designated at step S11 (step S12; NO), the owner terminal 2 receives the display information relating to the recommended tasks transmitted at step S23 by the management device 1 and displays the task selection view based on the display information (step S13). When the owner terminal 2 detects an input designating a task on the task selection view, it transmits the information on the designated task to the management device 1 (step S14). In this case, the management device 1 recognizes the designation task by receiving the information on the designated task transmitted at step S14 by the owner terminal 2 (step S24). Namely, in this case, the management device 1 regards the task indicated by the designation information received at step S24 as the designation task.

Next, when it is determined at step S22 that the designation task is designated or that the information on the designated task is received at step S24, the management device 1 generates shortage data information S2 regarding the shortage data that is lacked to perform the designation task (step S25). The management device 1 transmits the generated shortage data information S2 to the owner terminal 2. In this case, the owner terminal 2 receives the shortage data information S2 transmitted from the management device 1, and displays the data selection view based on the shortage data information S2 (step S15).

As described above, according to the first example embodiment, when the request information S1 which designates the possession data is received from the owner terminal 2, the management device 1 suitably notifies the owner terminal 2 of the shortage data information S2 relating to the shortage data that is lacked to perform the designation task. Thus, the data owner can suitably grasp shortage data lacked to perform the designation task and information regarding the data provider capable of providing the shortage data. Further, the management device 1 adds information indicative of the price and the increase in the accuracy regarding the shortage data to the shortage data information to be displayed on the owner terminal 2, which suitably provides useful information for the determination on whether or not the data owner needs to purchase the shortage data.

### Second Example Embodiment

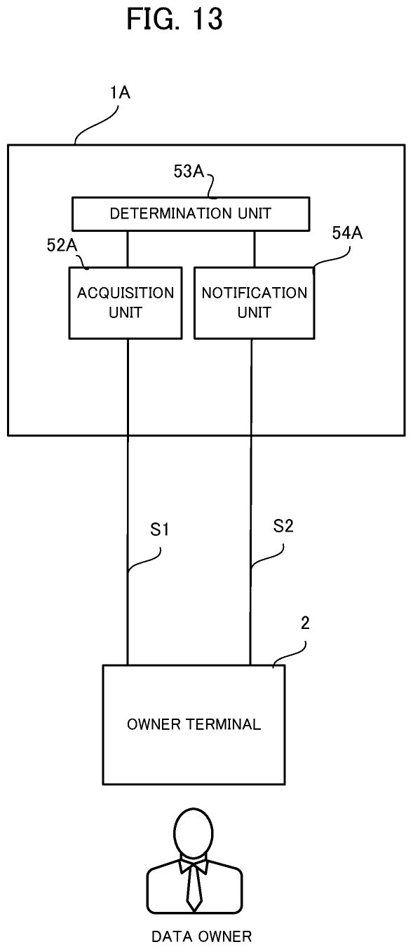

FIG. 13 is a functional block diagram of a management device 1A according to a second example embodiment. The management device 1A functionally includes an acquisition unit 52A, a determination unit 53A and a notification unit 54A.

The acquisition unit 52A acquires request information S1, which is information regarding possession data owned by a data owner, from an owner terminal 2 which the data owner uses. The determination unit 53A determines whether or not there is shortage data other than the possession data required to perform a designation task that is designated. The notification unit 54A notifies, when the determination unit 53A determines that there is the shortage data, the owner terminal 2 of shortage data information S2 that is information regarding shortage information.

According to the second example embodiment, the management device 1A can also suitably notify the owner terminal 2 of information regarding shortage data that is data lacked to perform the designation task.

The whole or a part of the example embodiments described above can be described as, but not limited to, the following Supplementary Notes.

[Supplementary Note 1]

A management device comprising:

an acquisition unit configured to acquire information regarding data owned by a data owner from an owner terminal which the data owner uses;

a determination unit configured to determine whether or not there is shortage data other than the data required to perform designation task that is designated; and

a notification unit configured to notify, when the determination unit determines that there is the shortage data, the owner terminal of information regarding the shortage data.

[Supplementary Note 2]

The management device according to claim 1,

wherein the information regarding the shortage data includes at least one of:

a price of the shortage data;

a difference of accuracy of the designation task due to presence or absence of the shortage data; or

a task related to the shortage data.

[Supplementary Note 3]

The management device according to claim 1 or 2,

wherein the acquisition unit acquires information regarding a budget for the shortage data from the owner terminal, and

wherein the notification unit notifies the owner terminal of information regarding the shortage data whose price is within limits of the budget.

[Supplementary Note 4]

The management device according to any one of claims 1 to 3,

wherein the determination unit further determines whether or not there is a task which can be performed by use of the data, and

wherein the designation task is the task which can be performed by use of the data and which is designated by the data owner.

[Supplementary Note 5]

The management device according to any one of claims 1 to 3,

wherein the acquisition unit acquires information regarding designation task in addition to information regarding the data from the owner terminal.

[Supplementary Note 6]

The management device according to any one of claims 1 to 5,

wherein the information regarding the shortage data includes information regarding a data provider who provides the shortage data.

[Supplementary Note 7]

The management device according to claim 6,

wherein the information regarding the data provider includes;

information regarding a price of the shortage data which the data provider provides; or

information regarding an increase in accuracy of the designation task on an assumption that the shortage data is used for the designation task.

[Supplementary Note 8]

The management device according to claim 6 or 7,

wherein the information regarding the data provider includes;

information regarding an evaluation relating to the data provider; or

information regarding a past record of providing the shortage data by the data provider.

[Supplementary Note 9]

A control method executed by a management device, the control method comprising:

acquiring information regarding data owned by a data owner from an owner terminal which the data owner uses;

determining whether or not there is shortage data other than the data required to perform designation task that is designated; and

notifying, when it is determined that there is the shortage data, the owner terminal of information regarding the shortage data.

[Supplementary Note 10]

A storage medium storing a program executed by a computer, the program causing the computer to function as:

an acquisition unit configured to acquire information regarding data owned by a data owner from an owner terminal which the data owner uses;

a determination unit configured to determine whether or not there is shortage data other than the data required to perform designation task that is designated; and

a notification unit configured to notify, when the determination unit determines that there is the shortage data, the owner terminal of information regarding the shortage data.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent Literatures mentioned in this specification are incorporated by reference in its entirety.

### DESCRIPTION OF REFERENCE NUMERALS

1, 1A Management device
2 Owner terminal
3, 4 Terminal device
21, 31, 41 Input unit
22, 32, 42 Output unit
13, 23, 33, 43 Storage unit
14, 24, 34, 44 Communication unit
15, 25, 35, 45 Control unit
100 Data market system

What is claimed is:

1. A management device comprising a processor configured to:
acquire information regarding data owned by a data owner from an owner terminal which the data owner uses;
determine whether or not there is shortage data other than the data required to perform designation task that is designated; and
notify, when it is determined that there is the shortage data, the owner terminal of information regarding the shortage data.

2. The management device according to claim 1,
wherein the information regarding the shortage data includes at least one of:
a price of the shortage data;
a difference of accuracy of the designation task due to presence or absence of the shortage data; or
a task related to the shortage data.

3. The management device according to claim 1,
wherein the processor acquires information regarding a budget for the shortage data from the owner terminal, and
wherein the processor notifies the owner terminal of information regarding the shortage data whose price is within limits of the budget.

4. The management device according to claim 1,
wherein the processor further determines whether or not there is a task which can be performed by use of the data, and
wherein the designation task is the task which can be performed by use of the data and which is designated by the data owner.

5. The management device according to claim 1,
wherein the processor acquires information regarding designation task in addition to information regarding the data from the owner terminal.

6. The management device according to claim 1,
wherein the information regarding the shortage data includes information regarding a data provider who provides the shortage data.

7. The management device according to claim 6,
wherein the information regarding the data provider includes;
information regarding a price of the shortage data which the data provider provides; or
information regarding an increase in accuracy of the designation task on an assumption that the shortage data is used for the designation task.

8. The management device according to claim 6,
wherein the information regarding the data provider includes;
information regarding an evaluation relating to the data provider; or
information regarding a past record of providing the shortage data by the data provider.

9. A control method executed by a management device, the control method comprising:
acquiring information regarding data owned by a data owner from an owner terminal which the data owner uses;
determining whether or not there is shortage data other than the data required to perform designation task that is designated; and
notifying, when it is determined that there is the shortage data, the owner terminal of information regarding the shortage data.

10. A non-transitory computer-readable storage medium storing a program executed by a computer, the program causing the computer to:
acquire information regarding data owned by a data owner from an owner terminal which the data owner uses;
determine whether or not there is shortage data other than the data required to perform designation task that is designated; and
notify, when it is determined that there is the shortage data, the owner terminal of information regarding the shortage data.
